(19) United States
(12) Patent Application Publication
(10) Pub. No.: US 2002/0055090 A1
(43) Pub. Date: May 9, 2002

(54) Composition for density gradient cell separation

(76) Inventor: Steven M. Woodside, Vancouver (CA)

Correspondence Address: Micheline Gravelle, Bereskin & Parr, Box 401, 40 King Street West, Toronto, ON, M5H 3Y2, CA

(21) Appl. No.: 09/951,784

(22) Filed: Sep. 14, 2001

Related U.S. Application Data
(60) Provisional application No. 60/232,879, filed on Sep. 15, 2000.

(51) Int. Cl. A01N 1/02

(52) U.S. Cl. 435/2

(57) ABSTRACT

A novel composition for density gradient separation is disclosed. The composition comprises (a) a red blood cell aggregating agent and (b) a density enhancing agent wherein the composition is iso-osmolar to the sample it is used on. Preferably, the osmolarity of the composition is from about 270 to about 300 mOsm and the red blood cell aggregating agent is hetastarch.

This application claims the benefit under 35 USC §119(e) from U.S. Provisional patent application serial No. 60/232,879, filed Sep. 15, 2000.

### FIELD OF THE INVENTION

This invention relates to a novel composition for cell separation based on the difference in buoyant density between various cell types and the composition.

### BACKGROUND OF THE INVENTION

Cell separation is widespread in clinical and research applications. A number of separation strategies exploit differences in the physical properties of various cell types, such as size and density, to isolate specific populations. In one class of separations polysaccharides (ex. methylcellulose, polysucrose, dextran), proteins (ex. BSA, gelatin) or other polymeric materials (ex. polyvinylpyrollidone) are used to isolate nucleated cells (NC) from red blood cells (RBC). These compounds induce RBC aggregation or rouleaux formation which increases the RBC sedimentation rate. Because NC sediment more slowly, they can be collected in the supernatant after RBC sedimentation is complete (Skoog and Beck, Blood, 11:436, 1956). Those versed in the art will know that this type of separation is time consuming and that NC recovery is dependent on the sedimentation time allowed. A more robust approach, known as density gradient separation, involves layering blood over a density separation medium (DSM) within a tube and then centrifuging the tube or allowing the cells to settle under gravity within the tube. The DSM is formulated such that the desired cells are buoyant in the DSM and the undesired cells settle.

Those practised in the art will distinguish between continuous density gradient separation and discontinuous density gradient separation. In continuous density gradient separation the DSM forms a continuous gradient in density from the top to the bottom of the DSM layer. This method allows very fine resolution of different cell populations as every cell settles to the point of neutral buoyancy within the DSM. The considerable disadvantages of this approach are two-fold. First of all, the gradient must be formed either before-hand or as part of the separation, requiring a lengthy centrifugation. Secondly, there is no distinct delineation between different cell populations, making it difficult to know which portion of the gradient contains the cells of interest.

In discontinuous density gradient separation the DSM has a constant density. Cells that are more dense than the DSM settle to the bottom of the vessel and cells that are buoyant in the DSM remain at the blood:DSM interface. Using this method a clearly defined band of the buoyant cells is formed at the interface. To resolve multiple cell densities, multiple layers of DSM formulated with different densities are used.

Materials for density separation media employed in the art include polysaccharides such as dextran, methylcellulose, and polysucrose (Ficoll™—Amersham Pharmacia Biotech) (Boyum, A., Nature 204:793-4, 1964; Boyum, A., Scand. J. Clin. Lab. Invest., 21(S 97): 77-89, 1968), iodinated x-ray contrast materials such as metrizamide, metrizoate, iohexol (Nycodenz™—Nycomed) and iodixanol (Ootiprep™—Nycomed), colloid suspensions of silica such as Percoll™ (Amersham Pharmacia Biotech) (Pertoft, H., et al., Exp. Cell Res. 110:449-457, 1977; Ulmer, A. J., H. D. Flad, J. Immunol. Meth. 30:1-10, 1979) as well as sucrose and caesium chloride. Many density separations are performed with whole blood or bone marrow, where the ratio of RBC:NC is up to 1000:1 or more. Although the majority of RBC are more dense than leukocytes, the presence of polysaccharides such as dextran, methylcellulose, and polysucrose increases the effectiveness of RBC removal by causing RBC aggregation through rouleaux formation. DSM composed solely of colloidal silica suspensions, or the many iocinated x-ray contrast materials do not deplete RBCs effectively when formulated for mononuclear cell (MNC) isolation. Ficoll-Paque™ (Amersham Pharmacia Biotech), a mixture of polysucrose and diatrizoate, combines the RBC depletion of polysucrose with the high density of metrizoate solutions to give a solution with a density and osmolarity suitable for isolation of lymphocytes. The formulation of Ficoll-paque derives from the work of Boyum.

Boyum (Nature 204:793-4, 1964) showed that leukocytes were isolated when blood was layered over a dense solution of methycellulose and Isopaque™ at a density of 1.09 such that the RBC were aggregated by the methycellulose and settled by gravity sedimentation while leukocytes were recovered at the interface. Later it was shown that mononuclear cells were isolated from blood at the blood:DSM interface of Ficoll-Isopaque mixtures with different densities. The impact of the osmolarity of the buoyant density medium on cell density was acknowledged, but the osmolarity of the Ficoll-isopaque mixture was not controlled independently of the density (Boyum, A., Scand J. Clin. Lab. Invest., 21(S97): 51-76, 77-89, 1968).

The normal range of osmolarity in bloods is between 270 and 300 mOsm. In hyper-osmolar media, the density of cells will increases due to efflux of water from the cells. The current dogma is that a hyper-osmolar solution is necessary to give a high purity and recovery of MNC from whole blood (Boyum, A., Scand. J. Immonol. 34:697-712, 1991; Boyum, A., Scand. J. Clin. Lab. Invest., 21(S97): 77-89, 1968) or of monocytes from leukocyte rich plasma (Boyum, A., Scand. J. Immonol. 34:697-712, 1991). Hyperosmolar solutions are also required to separate granulocytes from MNC and RBC (Boyum, A., Scand. J. Immonol. 34:697-712, 1991; Boyum, A., Scand. J. Clin. Lab. Invest., 21(S97): 51-76, 1968). However, solutions that are iso-osmolar to blood are more desirable that hyper-osmolar solutions, as cells in a hyper-osmolar environment will lose water, which can change the chemical activity of intracellular molecules, modifying cellular metabolism. Thus, there is the need for a DSM that is iso-osmolar to blood, that is comprised in part of an agent that induces RBC aggregation to effectively remove RBC, and that has a defined density for the isolation of specific cell populations using discontinuous density gradient separation.

### SUMMARY OF THE INVENTION

This invention comprises a novel density separation medium (DSM) useful for the isolation of different cell populations from whole blood by discontinuous density gradient separation. The novel medium is iso-osmolar to blood and is thus not harmfu to cells, nor does it change the concentration and chemical activity of species within the cells due to efflux of water from the cells.

Accordingly, the present invention provides a composition for the isolation of nucleated cells from a sample by dens ty gradient separation comprising (a) a red blood cell aggregating agent; and (b) a density enhancing agent wherein the composition is iso-osmolar to the sample. Preferably, the osmolarity of the composition is from about 270 to about 300 mOsm.

The present invention also provides a method for the isolation of nucleated cells from a sample by density gradient separation comprising (1) layering the sample over one or more layers of different density of a composition comprising (a) a red blood cell aggregating agent and (b) a density enhancing agent wherein the composition is iso-osmolar to the sample; (2) centrifuging the sample that is layered over the composition; and (3) isolating the nucleated cells from the composition:plasma interface.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE INVENTION

As hereinbefore mentioned, the present invention provides a novel density separation medium for the isolation of nucleated cells in a sample. The novel composition of the invention is improved over the compositions of the prior art as it is iso-osmolar to blood and therefore is not harmful to the cells. Importantly, the composition does not change the concentration and chemical activity of the components of the cells that is observed in a hyper-osmolar environment as a result of the efflux of water from the cells.

Accordingly, the present invention provides a composition for the isolation of nucleated cells from a sample by dens ty gradient separation comprising (a) a red blood cell aggregating agent; and (b) a density enhancing agent wherein the composition is iso-osmolar to the sample. Preferably, the osmolarity of the composition is from about 270 to about 300 mOsm.

The red blood cell aggregating agent can be any agent that can induce red blood cell aggregation or rouleaux formation. Preferably, the red blood cell aggregating agent is selected from the group consisting of hetastarch, pentastarch, methylcellulose, dextran and polysucrose.

The density enhancing agent can be any agent that can form a solution with a density greater than that of the solvent at the same temperature and pressure. Preferably, the density enhancing agent is a low molecular weight iodinated compound such as metrizoate, metrizamide, diatrizoate, iohexol, iodixanol, ioxaglate, iopamidol and amidotrizoate.

In order to prepare the novel density separation medium of the invention, the red blood cell aggregating agent is mixed with the density enhancing agent together with water until the desired density and osmolarity is achieved. Preferably, the composition contains between 1 and 50% by weight of the red cell aggregating agent and between 1 and 99% by weight of the density enhancing agent.

The novel density separation medium can be used for the continuous density gradient separation of low density nucleated cells in a sample. Accordingly, the present invention provides a method for the isolation of nucleated cells from a sample by dens ty gradient separation comprising (1) layering the sample over one or more layers of different density of a composition comprising (a) a red blood cell aggregating agent and (b) a density enhancing agent wherein the composition is iso-osmolar to the sample; (2) centrifuging the sample that is layered over the composition; and (3) isolating the nucleated cells from the composition:plasma interface.

A sample can be any sample that contains the nucleated cells to be separated and red blood cells. Preferably, the sample is selected from whole peripheral blood and fractions thereof, umbilical cord blood, bone marrow, spleen suspensions, liver suspensions, other tissue suspensions and lymph node suspensions, and cells from these aforementioned suspensions that have modified sedimentation characteristics due to association with particles such as buoyant particles, dense particles or red blood cells. The nucleated cells to be separated are preferably low density nuclear cells such as mononuclear cells or lymphocytes.

The following non-limiting examples are illustrative of the present invention:

### EXAMPLES

### Example 1

Preparation of the DSM of the Invention

A 6% hetastarch solution (Hextend—BioTime, Calif.) is mixed with defined volumes of 60% iodixanol (Optiprep—Sigma, Mo.) and distilled deionized water to give a solution with a defined density and an osmolarity of 290±5 mOsm. A range of dens ties can be prepared between 1.020 g/mL and 1.220 g/mL, of which a selection is presented in Table 1.

### Example 2

Method for Separation of Mononuclear Cells from Whole Peripheral Blood

A given volume of anti-coagulant treated blood is diluted 2× with phosphate buffered saline solution (STI, Vancouver, Canada). The DSM of the invention is prepared at a density of 1.075 g/mL, as described in Example 1, suitable for the isolation of mononuclear cells and a volume of the DSM equal to the original blood volume is added to the separation tube. The diluted blood is layered over the DSM in the separation tube, being careful to minimize mixing of the blood and DSM. The separation tube is centrifuged for 30 min at 400×g with no brake on the rotor. After centrifugation, the RBC and granulocytes form a visible pellet at the bottom of the tube and the mononuclear cells form a distinct band at the DSM:plasma interface. The plasma layer is removed to within 5 mm of the plasma:DSM interface and discarded. The desired cells at the plasma:DSM interface layer are recovered by removing the remaining plasma and the DSM up to within 5 mm of the pellet.

### Example 3

Comparison of the DSM of the Invention and Ficoll-Paque for MNC Isolation from Whole Blood

This example demonstrates the equivalert RBC depletion, MNC recovery and MNC purity obtained with the DSM of the invention and Ficoll-Paque when performing discontinuous density gradient isolation of mononuclear cells (MNC) from whole blood using the method described in Example 2. Blood was collected from donors and divided into two equal volumes. The first half volume was processed within 6 hours of collection, the second half volume was processed between 20 and 30 hours after collection. The results shown in Table 2 demonstrate that the MNC recovery, granulocyte contamination and RBC contamination were equivalent using both media.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

TABLE 1
Volumes of hetastarch, iodixanol and water required for preparation
of 100 mL of DSM at various different densities and constant
osmolarity iso-osmolar to blood.

| Desired | | | | Osmolarity of |
|---|---|---|---|---|
| density | 6% hetastarch | 60% iodixanol | water | DSM |
| (g/ml) | (mL) | (mL) | (ml) | (mOsm) |
| 1.065 | 76.5 | 14.4 | 9.2 | 291 |
| 1.068 | 74.5 | 15.5 | 10.0 | 291 |
| 1.072 | 73.6 | 16.8 | 9.6 | 285 |
| 1.077 | 72.3 | 18.5 | 9.2 | 288 |
| 1.081 | 73.2 | 19.6 | 7.2 | 294 |

TABLE 2
MNC isolation from whole blood by density gradient centrifugation using
the DSM of the invention and Ficoll-Paque for (n = 4) samples. Values are
average ± standard error of the mean.

| | MNC | | RBC |
|---|---|---|---|
| | recovery | Granulocyte | contamination |
| | (% from | contamination | (total # RBC) |
| | start) | (% of enriched) | (x10⁶) |
| Fresh blood | | | |
| Ficoll-Paque | 63 ± 18 | 4.8 ± 1.3 | 1.8 ± 1.3 |
| DSM of the | 59 ± 12 | 1.7 ± 0.2 | 1.7 ± 1.2 |
| invention | | | |
| One-day old blood | | | |
| Ficoll-Paque | 31 ± 6 | 26 ± 7.6 | 0.7 ± 0.14 |
| DSM of the | 33 ± 14 | 14 ± 4.5 | 1.5 ± 1.5 |
| invention | | | |

I claim:

1. A composition for the isolation of nucleated cells from a sample by density gradient separation comprising (a) a red blood cell aggregating agent; and (b) a density enhancing agent wherein the composition is iso-osmolar to the sample.

2. A composition according to claim 1 wherein the composition has an osmolarity within ±5% of the sample osmolarity.

3. A composition according to claim 1 wherein the osmolarity of the composition is from about 270 to about 300 mOsm.

4. A composition according to claim 1 wherein the red blood cell aggregating agent is selected from the group consisting of hetastarch, pentastarch, methylcellulose, dextran and polysucrose.

5. A composition according to claim 1 wherein the density enhancing agent is a low molecular weight iodinated compound.

6. A composition according to claim 5 wherein the density enhancing agent is selected from metrizoate, metrizamide, diatrizoate, iohexol, iodixanol, ioxaglate, iopamidol and amidotrizoate.

7. A composition according to claim 1 wherein the red blood cell aggregating agent is hetastarch.

8. A method for the isolation of nucleated cells from a sample by density gradient separation comprising (1) layering the sample over one or more layers of different density of a composition comprising (a) a red blood cell aggregating agent and (b) a density enhancing agent wherein the composition is iso-osmolar to the sample (2) centrifuging the sample that is layered over the composition; and (3) isolating the nucleated cells from the composition:plasma interface.

9. A method according to claim 8 wherein the sample is selected from whole peripheral blood or fractions thereof, umbilical cord blood, bone marrow, spleen suspensions, liver or other tissue suspensions and lymph node suspensions, and cells from these aforementioned suspensions that have modified sedimentation characteristics due to association with particles such as buoyant particles, dense particles or red blood cells.

10. A method according to claim 8 wherein the nucleated cells are mononuclear cells or lymphocytes.

11. A method according to claim 8 wherein the composition has an osmolarity within ±5% of the sample osmolarity.

12. A method according to claim 8 wherein the osmolarity of the solution is from about 270 to about 300 mOsm.

13. A method according to claim 8 wherein the red blood cell aggregating agent is selected from the group consisting of hetastarch, pentastarch, methylcellulose, dextran and polysucrose.

14. A method according to claim 8 wherein the red blood cell aggregating agent is hetastarch.

15. A method according to claim 8 where in the density enhancing agent is a low molecular weight iodinated compound.

16. A method according to claim 15 wherein the density enhancing agent is selected from metrizoate, metrizamide, diatrizoate, iohexol, iodixanol, ioxaglate, iopamidol and amidotrizoate.
